(19) United States
(12) Patent Application Publication
(10) Pub. No.: US 2020/0323050 A1
(43) Pub. Date: Oct. 8, 2020

(54) MICROWAVE DEVICE

(71) Applicant: CONEY INTERNATIONAL K.S., Bratislava (SK)

(72) Inventors: Horst LINN, Hirschbach (DE); Ivan IMENOKHOYEV, Sulzbach-Rosenberg (DE); Joachim KORNAUTH, Wien (AT)

(73) Assignee: CONEY International k.s., Bratislava (SK)

(21) Appl. No.: 16/063,095

(22) PCT Filed: Dec. 2, 2016
(86) PCT No.: PCT/EP2016/079546

§ 371 Date: Jun. 15, 2018

(30) Foreign Application Priority Data
Dec. 18, 2015 (EP) 15201322.3

(51) Int. Cl. H05B 6/64; H05B 6/70; A21D 17/00

(52) U.S. Cl. CPC H05B 6/6411; H05B 6/6402; H05B 6/707; H05B 2206/044; H05B 6/642; A21D 17/006; H05B 6/6464

(57) ABSTRACT

The invention relates to a microwave oven for material to be heated, in particular food material (40). The microwave oven (10) has an oven housing (12), to the housing cover (14) of which a number of microwave radiation sources (18) is coupled by means of microwave coupling elements (16). The microwave coupling elements (16) protrude from the housing cover (14) and are distributed in the peripheral direction. At least one material holding device (22) for the material (40) is provided in the oven housing (12), which material holding device can be rotated about a central axis (26) by means of a drive device (24). The at least one material holding device (40) is formed by a rotary plate (28) for holding the material (40) in a defined, positionally accurate manner.

The invention relates to a microwave oven for material to be heated, in particular to be thawed, especially food material, within a short period of time.

A continuous microwave oven is known from DE 197 38 882 C1, comprising oven modules arranged one behind the other in a row. Each oven module has a cylindrical housing cover. A microwave radiation source is attached to each housing cover. The microwave radiation sources of the oven modules arranged one behind the other in a row are preferably offset by the same angle in the circumferential direction. The microwave radiation source projects radially away from the associated oven module.

The invention is based on the object of creating a microwave oven of the type mentioned above, with which it is possible within a short time span of e.g. ≤1 minute to heat edible material, in particular food material, in particular deep-frozen, frozen material, and to make them edible.

This object is solved according to the invention by the features of claim 1, i.e. in that the microwave oven has an oven housing to whose housing cover at least one microwave radiation source is coupled by means of a microwave coupling element, the microwave coupling element projecting away from the housing cover distributed in the circumferential direction, and at least one material holding device for the material is provided in the oven housing which is rotatable about a central axis by means of a drive device, the at least one material holding device being formed by a rotary plate which is provided for holding the material to be heated, in particular the material to be thawed, in exact position.

With the microwave oven according to the invention, for example, two, three or four microwave radiation sources can be coupled to the housing cover in an evenly distributed manner by means of associated microwave coupling elements, so that the microwaves are evenly distributed inside the cylindrical oven housing with optimum turbulence of the microwave field.

In the oven housing, more than one material holding device may be provided for material to be heated, in particular to be thawed, which are axially spaced from one another. Preferably, only one single material holding device is provided in the oven housing for the material to be heated, in particular the material to be thawed, which is arranged axially centrally in the oven housing and can be rotated about the central axis of rotation by means of the drive device.

It may be useful if the housing cover of the oven housing has a heating device to prevent condensation. The heating device can be formed by an electric resistance heater that surrounds the housing cover. It is also possible that the housing cover is at least partially made of a material that exhibits such an eddy current loss under the influence of microwaves that self-heating is caused.

In the case of the microwave oven according to the invention, it has proved useful if the rotary plate can be removed from the oven housing for loading with material to be heated, in particular to be thawed, so that the rotary plate can be loaded with material to be heated, in particular to be thawed, from outside the microwave oven and inserted into the microwave oven when loaded.

The rotary plate can be connected to the drive device preferably by transmitting torque. This can be achieved, for example, by a form-fit connection, such as a spring-groove connection, a locking pin connection or the like, between the rotary plate and the drive device.

The respective microwave coupling device is preferably formed by a waveguide. The respective waveguide with its end remote from the associated microwave radiation source preferably opens tangentially into the housing cover of the cylindrical oven housing.

The rotary plate is suitably designed with material holding means, which are equidistantly spaced along at least one pitch circle concentric to the central axis. The material holding means can be holes, recesses, cavities, loop elements, clamping elements or the like.

The rotary plate can, for example, be disc-shaped over its entire surface with the holes and/or recesses and/or cavities. Another possibility is that the rotary plate for weight reduction is designed as a web or ribbed structure with corresponding holes, loop elements and/or clamping elements, which are confined, i.e. formed, by web or rib edges.

The rotary plate can adapted in such a way that the material to be heated is set in motion that is not a rotation about the central axis. This device can be implemented, for example, by means of a gear which moves the material holding means arranged on the rotary plate around axes deviating from the central axis.

In the rotary plate, the material holding means are preferably evenly spaced along at least one pitch circle concentric to the central axis. The material holding means formed in the rotary plate have clear dimensions which are adapted to the material to be heated, in particular to be thawed, in such a way that the material, in particular food material, extends axially defined through the rotary plate and is held by the rotary plate in a defined, precise and reliable way.

It can be advantageous if the material holding means are formed with spaced apart, partial contact surfaces in order to allow a discharge of steam and/or moisture between the rotary plate and the material to be heated, in particular to be thawed. The partial contact surfaces can be realized, for example, by the fact that the edge of the material holding means formed for example by holes is corrugated, toothed, or the like.

The rotary plate is preferably made of a microwave-transparent material or of a hybrid, i.e. parts made of a material that can easily be coupled to a microwave.

In the rotary plate, for example, three to nine material holding means can be equidistantly provided along the at least one pitch circle.

It is useful if a collecting device made of microwave-permeable material is provided removably in the oven housing for collecting moisture and/or dirt particles. The collecting device can be cleaned, i.e. washed, manually or with the aid of a dishwasher after it has been removed from the oven housing.

In the microwave oven according to the invention, the drive device for the at least one holding means is preferably located in the area of the bottom of the oven housing. The bottom of the oven housing can be formed with a central cap-like bulge through which a cavity is defined on the lower side in which the drive device formed by a motor is provided.

The drive device can be surrounded by a microwave reflecting cap element, which is immovable. With such a design, the cap element can be designed with a smooth surface. However, it can be advantageous if the cap element is provided to rotate about the central axis and is designed for dispersing microwave reflection with a non-smooth, e.g. ribbed, knobbed, corrugated and/or dented surface. The advantage of such a design of the latter type is that the microwaves are not only reflected by the cap element but also scattered, so that the effect of the microwaves on the material to be heated, in particular the material to be thawed, in particular food material, is further improved, i.e. optimised.

With the aid of the microwave-reflecting cap element, the material defined by the rotary plate and precisely positioned is not only exposed to microwaves radially on the outside but also on its radial inside by means of the microwave-reflecting cap element, so that an even effect of the microwaves on the material and thus optimum thawing properties, especially for the material, result.

According to the invention, the oven housing can be cylindrical and have a cover with a protective device against leakage radiation. Depending on the respective oven load, the protective device can form an λ/4 or λ/2 choke, for example.

When the following refers to a cylindrical oven housing or a cylindrical housing cover, it is understood that not only a circular smooth base profile is meant, but that the base profile can also be polygonal smooth or wavy.

In order to prevent the moisture produced in the cylindrical oven housing from becoming effective on the material to be heated, in particular the material to be thawed, it may be useful if the housing top cover has a suction device with which the moisture produced is sucked from the oven housing and discharged. The suction device can be formed by an exhaust fan. Another possibility is that the housing top cover is designed with perforation holes so that the warm air in the oven housing rises upwards and flows out of the oven housing through the perforation holes.

It has proved to be advantageous if the microwave oven has a weighing device for determining the load of the material holding device. The weighing device can also be used to control the power of the microwave oven. With the help of the weighing device, it is also possible in an advantageous way to prevent incorrect loading of the microwave oven according to the invention, e.g. with ham and cheese toast, potatoes or the like.

The respective microwave radiation source is preferably formed by a magnetron, to which a fan is connected for cooling, and the respective magnetron is preferably connected to the cylindrical housing cover by means of a pipeline, through which the heat loss generated in the magnetron is introduced into the interior of the cylindrical oven housing. It may be useful to provide a filter device in the respective flow channel.

The advantage of such a design of the microwave oven according to the invention is that the waste heat of the respective magnetron can be introduced into the interior of the cylindrical oven housing with the aid of the associated fan in order to apply said waste heat to the moisture material or moisture produced during heating, in particular thawing of the material or product, in particular food material, and to suck off and remove the moisture from the interior of the cylindrical oven housing by means of the suction device.

The respective pipeline, by means of which the associated magnetron is fluidically connected to the housing cover, appropriately opens tangentially into the cylindrical housing cover.

The microwave oven according to the invention is preferably used for food material to be heated, in particular to be thawed, which has a defined shape and which being inserted into a dimensionally stable receiving shell body is introduced into the microwave oven for heating, in particular for thawing. The respective receiving shell body for the material to be heated, in particular the material to be thawed, is preferably formed by a dough material with a neutral taste or a certain flavour, in particular a waffle, as it is used, for example, for ice cream.

The food material in question may be vegetables and/or fruit and/or meat and/or fish or the like, which is prepared in paste-like form and/or in small pieces and which is stored and held on stock in conical or truncated conical form deep-frozen e.g. in a freezer until sale. Correspondingly, the dimensionally stable receiving shell bodies made of the dough material are stored until use, i.e. for combination with the deep-frozen food material. For sale, the deep-frozen food material is placed in a suitable, dimensionally stable receiving shell body and then the dimensionally stable receiving shell body with the food material to be heated, in particular to be thawed, is introduced into the microwave oven with the aid of the material holding device, and the microwave oven is switched on so that within a short period of e.g. less than one minute the food material is heated with the receiving shell body, in particular thawed, and is available for consumption.

The microwave oven according to the invention, for example, is able to heat frozen food material from −20° C. to +80° C. within a short time span of ≤1 minute.

Further details, features and advantages result from the following description of an embodiment schematically shown in the drawing of the microwave oven according to the invention or essential details thereof, whereby it should be explicitly clarified that the proportions in axial and radial direction of the microwave oven do not correspond to the real conditions but only serve to clarify the invention.

FIG. 1 shows a schematic view of the microwave oven from above,

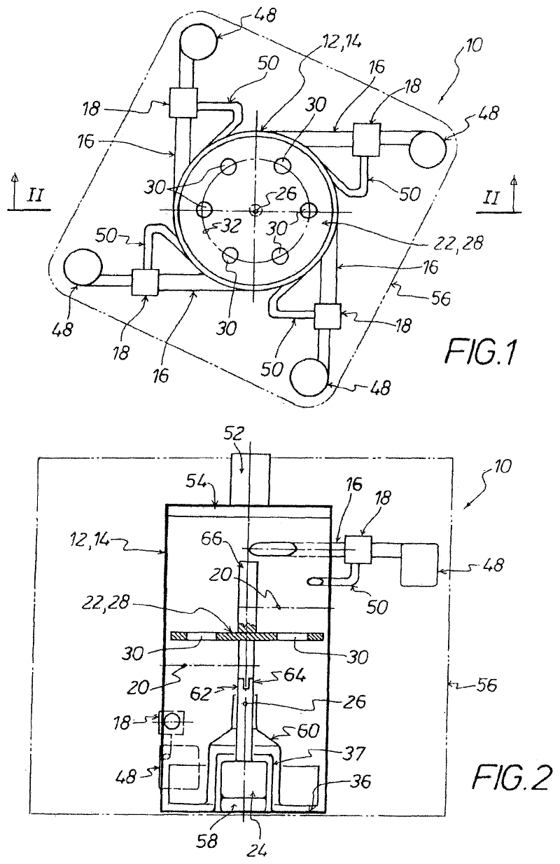

FIG. 2 shows a schematic section along the intersection line 11-11 in FIG. 1, and

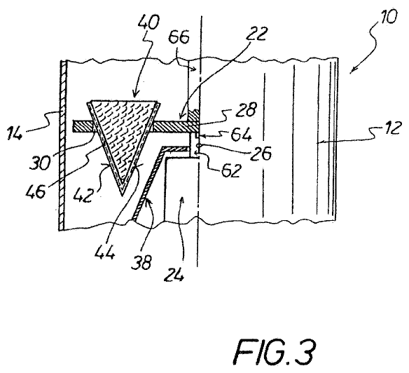

FIG. 3 shows a section by section of the microwave oven—similar to the section shown in FIG. 2, in particular to illustrate the microwave reflecting cap element.

FIG. 1 illustrates an embodiment of the microwave oven 10, which has an oven housing 12 with a cylindrical housing cover 14. A number of microwave coupling elements 16 are coupled to the housing cover 14, which project tangentially from the cylindrical housing cover 14, preferably evenly distributed in the circumferential direction. The microwave coupling elements 16 are used to couple associated microwave radiation sources 18 to the cylindrical oven housing 12 of the microwave oven 10.

As can be seen in FIG. 2, the microwave radiation sources 18 are axially equidistantly offset from one another by means of the associated microwave coupling elements 16. FIG. 2 illustrates four microwave coupling elements 16, whereby only the two microwave coupling elements at the end are shown in the drawing. The two middle microwave coupling elements are only indicated by dashed lines 20.

It is understandable for a person skilled in the art that any number of microwave radiation sources can be used, depending on their output and the volume of space to be heated.

According to the invention, it is also possible that a number of microwave radiation sources 18 with their associated microwave coupling elements 16 are arranged in a common plane distributed in the circumferential direction and not axially offset.

In the cylindrical oven housing 12, a material holding device 22 is provided axially centrally, which can be driven about a central axis 26 by means of a drive device 24.

The material holding device 22 has a rotary plate 28, which is designed in particular for temporarily holding food material to be heated or deep-frozen and thawed with material holding means 30. The material holding means 30 are equidistantly spaced along a pitch circle 32 concentric to the central axis 26. For example, the rotary plate 28 is designed with five or six material holding means 30.

The material holding means 30, for example, are designed as holes; they can also be formed by recesses, cavities, loop elements, clamping elements or the like.

The drive unit 24 provided for the material holding means 22 formed by a rotary plate 28 is arranged in the area of the base 36 of the cylindrical oven housing 12. For this purpose, the base 36 is designed with a cap-like bulge 37.

The drive device 24 is located in the space limited at the top by the bulge 37.

FIG. 3 illustrates an embodiment in which the drive device 24 formed by a motor is surrounded by a microwave-reflecting cap element 38, so that the food material 40 to be heated, in particular deep-frozen and thawed, is acted upon with microwaves not only on its radially outer side 42 but also on its radially inner side 44 in order to effect a uniform and rapid heating, in particular thawing of the food material 40.

The cap element 38 can be immovable and formed with a smooth surface. Another possibility is that the cap element 38 is provided to rotate about the central axis 26 and is formed for dispersing microwave reflection with a non-smooth, i.e. ribbed, knobbed, corrugated and/or dented surface.

As can also be seen clearly in FIG. 3, the food material 40 to be heated, in particular to be thawed, has a conical shape and is inserted into a dimensionally stable receiving shell body 46. The respective dimensionally stable receiving shell body 46 consists of an edible, tasteless or flavoured dough material, so that the food material 40 after thawing and removal from the microwave oven 10 can be eaten together with the receiving shell body 46

The receiving shell body 46 can, for example, be formed by a waffle, as it has been used up to now for eating portions of ice cream.

FIGS. 1 and 2 also show that the respective microwave radiation source 18 formed by a magnetron is connected to a fan 48 for cooling. The respective microwave radiation source 18 is also connected to the cylindrical housing cover 14 by means of a pipeline 50; the respective pipeline 50 opens tangentially oriented into the interior 34 of the cylindrical oven housing 14. The heat loss generated in the microwave radiation sources 18 is introduced through the pipes 50 into the interior 34 of the cylindrical oven housing 12 in order to heat the moisture generated during heating, in particular thawing of deep-frozen food material 40, and to suck it out of the microwave oven 10 by means of a suction device 52. The suction device 52 formed by a fan is arranged on the housing top cover 54 of the cylindrical oven housing 12 of the microwave oven 10.

The housing top cover 54 is preferably designed with a protective device against leakage radiation, which is designed as an λ/4 or λ/2 choke depending on the oven load.

In FIGS. 1 and 2, a device housing 56 is indicated by a thin dotted line.

FIG. 2 also illustrates schematically a weighing device 58, which is assigned to drive device 24. With the aid of the weighing device 58 it is advantageously possible to determine the load of the material holding device 22 and to control the power of the microwave oven 10 depending on the respective load. The weighing unit 58 is also suitable for preventing the microwave oven 10 from operating in the event of incorrect loading, e.g. with ham and cheese toast, potatoes or the like.

FIG. 2 also shows a removable collecting device 60 in the oven housing 12, which is used to collect moisture and/or dirt particles. After removing the collecting device 60 from the oven housing 12, it can be cleaned to remove dirt particles and/or moisture from the collecting device 60. Cleaning can be done manually or mechanically, e.g. by means of a dishwasher.

The rotary plate 28 is detachably coupled to the drive shaft 62 of drive device 24 by means of a form-fit connection 64. The rotary plate 28 has a rod-shaped handle 66 with which the rotary plate 28 can be separated from the form-fit connection and removed from the oven housing 12 as soon as the housing top cover 54 has been actuated to open the oven housing 12, i.e. swivelled open, for example.

List of reference numerals:

| | |
|---|---|
| 10 | Microwave oven (for 40) |
| 12 | Cylindrical oven housing (of 10) |
| 14 | Cylindrical housing cover (of 12) |
| 16 | Microwave coupling element (from 10 to 14 for 18) |
| 18 | Microwave radiation source (out of 10) |
| 20 | Dot-dashed line (for 16, 18) |
| 22 | Material holding device (from 10 to 12) |
| 24 | Drive device (for 22) |
| 26 | Central axis (of 10) |
| 28 | Rotary plate (of 22) |
| 30 | Material holding means (from 28 to 32) |
| 32 | Pitch circle |
| 34 | Base (of 12) |
| 36 | Bulge (from 36 for 24) |
| 38 | Microwave reflecting cap element (from 10 for 24) |
| 40 | Material to be heated, in particular to be thawed |
| 42 | Radial outside (of 40) |
| 44 | Radial inside (of 40) |
| 46 | Dimensionally stable receiving sleeve body (for 40) |
| 48 | Fan (for 18) |
| 50 | Pipeline (between 18 and 14) |
| 52 | Suction fan (from 10 to 12 or 54) |
| 54 | Housing top cover (of 12) |
| 56 | Housing (of 10) |
| 58 | Weighing equipment (of 10) |
| 60 | Collecting device (in 12) |
| 62 | Drive shaft (from 24 for 30) |
| 64 | Form-fit connection (for 26) |
| 66 | Handle (on 28) |

1. Microwave oven, comprising:
an oven housing, at least one microwave radiation source being coupled to its housing cover by means of a microwave coupling element, the microwave coupling element projecting away from the housing cover distributed in the circumferential direction, and at least one material holding device for a material to be heated being provided in the oven housing, which is rotatable about an axis by means of a drive device, the at least one material holding device being formed by a rotary plate which is provided for holding the material to be heated, in particular material to be thawed, in exact positions.

2. Microwave oven according to claim 1, characterized in that in that at least two, preferably three or four microwave radiation sources with their microwave coupling elements are provided on the housing cover of the oven housing axially offset from one another.

3. Microwave oven according to claim 1, characterized in that the housing cover of the oven housing has a heating device for preventing the formation of condensation water.

4. Microwave oven according to claim 1, characterized in that the rotary plate can be removed from the cylindrical oven housing for loading with material to be heated, in particular material to be thawed.

5. Microwave oven according to claim 1, characterized in that the respective microwave coupling device is formed by a waveguide.

6. Microwave oven according to claim 1, characterized in that the rotary plate is formed with material holding means which are provided equidistantly spaced apart along at least one pitch circle concentric with the central axis and/or in that the material holding means are formed by holes, recesses, cavities, loop elements and/or clamping elements.

7. Microwave oven according to claim 6, characterized in that, in that the material holding means are designed with spaced apart, partial contact surfaces in order to allow a discharge of steam and/or moisture between the rotary plate and the material to be heated, in particular material to be thawed.

8. Microwave oven according to claim 1, characterized in that in that a collecting device made of microwave-permeable material is provided in the oven housing for collecting moisture and/or dirt particles.

9. Microwave oven according to claim 1, characterized in that in that the drive device provided for the at least one holding device is arranged in the region of the base of the cylindrical oven housing.

10. Microwave oven according to claim 9, characterized in that the drive device is surrounded by a microwave reflecting cap element, and/or in that the microwave apparatus has a weighing device for determining the loading of the material holding device.

11. Microwave oven according to claim 10, characterized in that, in that the cap element is provided immovable and/or in that the cap element is provided to rotate about the central axis and is designed for dispersing microwave reflection with a non-smooth, ribbed, nubby, corrugated and/or dented surface.

12. Microwave oven according to claim 1, characterized in that the oven housing is cylindrical and has a housing top cover with a protective device against leakage radiation and/or in that the housing top cover has a suction device.

13. Microwave oven according to claim 1, characterized in that the respective microwave radiation source is formed by a magnetron to which a fan is connected for cooling, and in that the respective magnetron is fluidically connected to the cylindrical housing cover by means of a pipeline, through which the heat loss generated in the magnetron is introduced into the interior of the cylindrical oven housing.

14. Use of the microwave oven according to claim 1 for food material to be heated, in particular food material to be thawed, which has a defined shape and which is inserted into a conformal receiving shell body, for heating, in particular thawing, in the microwave oven.

15. Use according to claim 14, the respective receiving shell body for the material to be heated, in particular the material to be thawed, being formed from a dough material which has no or a certain taste, in particular a waffle.
